(19) United States
(12) Patent Application Publication
(10) Pub. No.: US 2010/0182734 A1
(43) Pub. Date: Jul. 22, 2010

(54) CAPACITOR AND PRODUCTION METHOD THEREOF

(76) Inventors: Tailu Ning, Saitama-shi (JP); Hironao Fujiki, Takasaki-shi (JP); Kazuyoshi Yoshida, Kazo-shi (JP)

Correspondence Address: OSTROLENK FABER GERB & SOFFEN, 1180 AVENUE OF THE AMERICAS, NEW YORK, NY, 100368403, US

(21) Appl. No.: 12/666,300

(22) PCT Filed: Jun. 19, 2008
(86) PCT No.: PCT/JP2008/061235

§ 371 Date: Dec. 23, 2009

(30) Foreign Application Priority Data
Jun. 26, 2007 (JP) 2007-167442

(51) Int. Cl. H01G 9/07; H01G 9/00

(52) U.S. Cl. 361/524; 427/80

(57) ABSTRACT

A capacitor including an anode composed of a valve metal and having unevenness formed in the surface thereof, a dielectric layer formed by oxidizing the surface of the anode, and a cathode formed on the surface of the dielectric layer and having a solid electrolyte layer containing a π-conjugated conductive polymer and a polyanion, wherein a portion of, or all of, the cathode-side surface of the dielectric layer is treated with a salt.

Priority is claimed on Japanese Patent Application No. 2007-167442, filed Jun. 26, 2007, the content of which is incorporated herein by reference.

### BACKGROUND OF THE INVENTION

1. Field of the Invention

The present invention relates to a capacitor such as an aluminum electrolytic capacitor, a tantalum electrolytic capacitor or a niobium electrolytic capacitor, and a production method thereof.

2. Description of Related Art

In recent years, the digitalization of electronic equipment has been accompanied by a growing demand for reductions in the high-frequency region impedance (the equivalent series resistance: ESR) of the capacitors used in the electronic equipment. Conventionally, in order to satisfy these demands, capacitors have been used in which an oxide film of a valve metal such as aluminum, tantalum or niobium is used as a dielectric body, and a film of a π-conjugated conductive polymer such as a polypyrrole or a polythiophene is formed on the surface of the dielectric body and functions as a cathode.

As disclosed in Patent Document 1, the structures of these capacitors generally include an anode composed of a valve metal and having unevenness formed in the surface thereof, a dielectric layer formed by oxidizing the surface of the anode, and a cathode prepared by laminating a solid electrolyte layer and a cathode conductive layer onto the dielectric layer. Widely known methods for forming a film of a π-conjugated conductive polymer include electrolytic polymerization methods (see Patent Document 2) and chemical oxidative polymerization methods (see Patent Document 3).

However, in an electrolytic polymerization method, an electrolytic conductive layer composed of manganese oxide must be formed in advance on the surface of the anode, which is not only extremely complex, but the resulting manganese oxide exhibits poor conductivity, which weakens the effect of using a highly conductive π-conjugated conductive polymer.

On the other hand, in a chemical oxidative polymerization method, the polymerization time is very long, and repeated polymerizations must be performed to ensure a film of satisfactory thickness, meaning the production efficiency for the capacitor is poor. The conductivity also tends to be low.

Accordingly, Patent Document 4 proposes a method in which aniline is subjected to a chemical oxidative polymerization in the presence of a polyanion having sulfo groups or carboxyl groups or the like, thereby forming a water-soluble polyaniline, and then applying and drying an aqueous solution of the polyaniline to form a coating.

[Patent Document 1]

Japanese Laid-Open Patent Application No. 2003-37024

[Patent Document 2]

Japanese Unexamined Patent Application, First Publication No. Sho 63-158829

[Patent Document 3]

Japanese Unexamined Patent Application, First Publication No. Sho 63-173313

[Patent Document 4]

Japanese Unexamined Patent Application, First Publication No. Hei 7-105718

### SUMMARY OF THE INVENTION

Capacitors are generally required to be of small size and have a high electrostatic capacitance. However, with the capacitor disclosed in Patent Document 4 having a polyaniline solution coating as a solid electrolyte layer, achieving a high capacitance is problematic. Further, additional reductions in the ESR for the capacitor are also required.

An object of the present invention is to provide a capacitor that is able to realize a high capacitance, and also has a low ESR. Furthermore, another object of the present invention is to provide a method of producing a capacitor that is capable of manufacturing a capacitor having a high capacitance and a low ESR at a high level of productivity.

The results of investigations conducted by the inventors of the present invention suggested that the reason, a high electrostatic capacitance could not be obtained by applying a coating of a solution containing a π-conjugated conductive polymer and a polyanion, was because the solution containing the high molecular weight π-conjugated conductive polymer and polyanion was inhibited from penetrating deeply into the interior of the dielectric layer. Accordingly, the inventors focused their investigations on methods for improving the affinity of the dielectric layer surface for the π-conjugated conductive polymer and the polyanion. As a result, they invented the capacitor and the producing method described below.

In other words, the present invention includes the aspects described below.

[1] A capacitor having an anode composed of a valve metal and having unevenness formed in the surface thereof, a dielectric layer formed by oxidizing the surface of the anode, and a cathode formed on the surface of the dielectric layer and having a solid electrolyte layer containing a π-conjugated conductive polymer and a polyanion, wherein

a portion of, or all of, the cathode-side surface of the dielectric layer is treated with a salt.

[2] A capacitor according to [1] above, wherein the salt is a salt of a nitrogen-containing cation and an anion.
[3] A capacitor according to [1] or [2] above, wherein a conductivity improver is added to the salt used for treating the cathode-side surface of the dielectric layer.
[4] A capacitor according to any one of [1] to [3] above, wherein an ion-conducting compound is added to the salt used for treating the cathode-side surface of the dielectric layer.
[5] A method of producing a capacitor including: forming a dielectric layer by oxidizing the surface of an anode composed of a valve metal, treating the surface of the dielectric layer with a treatment liquid containing a salt and a solvent, and forming a solid electrolyte layer by applying a conductive polymer solution containing a π-conjugated conductive polymer, a polyanion and a solvent to the surface of the dielectric layer that has been treated with the salt.
[6] A method of producing a capacitor according to [5] above, wherein the salt is a salt of a nitrogen-containing cation and an anion.
[7] A method of producing a capacitor according to [5] or [6] above, wherein the treatment liquid further contains a conductivity improver.
[8] A method of producing a capacitor according to any one of [5] to [7] above, wherein the treatment liquid further contains an ion-conducting compound.
[9] A method of producing a capacitor according to any one of [5] to [8] above, wherein the pH of the treatment liquid at 25° C. is within a range from 3 to 12.

A capacitor of the present invention is able to realize a high capacitance, and yet also has a low ESR. A method for manufacturing a capacitor according to the present invention is capable of manufacturing a capacitor having a high capacitance and a low ESR at a high level of productivity.

### BRIEF DESCRIPTION OF THE DRAWINGS

FIG. 1 is a cross-sectional view illustrating one embodiment of a capacitor of the present invention.

### DESCRIPTION OF THE REFERENCE SYMBOLS

10: Capacitor
11: Anode
12: Dielectric layer
13: Cathode
13a: Solid electrolyte layer
13b: Cathode conductive layer
14: Salt

### DETAILED DESCRIPTION OF THE INVENTION

### Capacitor

An embodiment of a capacitor of the present invention is described below.

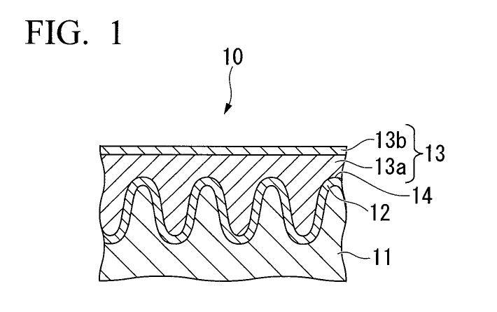

FIG. 1 is a diagram illustrating the structure of the capacitor of this embodiment. This capacitor 10 basically includes an anode 11 composed of a valve metal, a dielectric layer 12 that is formed by oxidation of the surface of the anode 11, and a cathode 13 that is formed on top of the dielectric layer 12.

### <Anode>

Examples of the valve metal that constitutes the anode 11 include aluminum, tantalum, niobium, titanium, hafnium, zirconium, zinc, tungsten, bismuth and antimony. Of these, aluminum, tantalum and niobium are preferred.

Specific examples of the anode 11 include anodes prepared by etching an aluminum foil to increase the surface area and subsequently subjecting the surface to an oxidation treatment, and anodes prepared by subjecting the surface of a sintered body of tantalum particles or niobium particles to an oxidation treatment to form porous pellets. Anodes prepared via the above processes have unevenness formed within the surface.

### <Dielectric Layer>

The dielectric layer 12 is formed, for example, by anodic oxidation of the surface of the anode 11 within an electrolyte such as an aqueous solution of ammonium adipate. Accordingly, as illustrated in FIG. 1, the dielectric layer 12 conforms and follows the uneven surface of the anode 11.

In the present embodiment, the surface of the dielectric layer 12 on the side of the cathode 13 is treated with a treatment liquid containing a salt in the manner described below. Accordingly, a salt 14 exists on the surface of the dielectric layer 12 facing the cathode 13.

Further, in order to enable a further reduction in the ESR of the capacitor 10, a conductivity improver described below is preferably added to the salt used in treating the surface of the dielectric layer 12 on the side of the cathode 13.

In those cases where a conductivity improver is added to the salt, the conductivity improver also exists on the surface of the dielectric layer 12 facing the cathode 13.

Moreover, in order to enable a further reduction in the ESR of the capacitor 10, an ion-conducting compound described below is preferably added to the salt used in treating the surface of the dielectric layer 12 on the side of the cathode 13. In those cases where an ion-conducting compound is added to the salt, the ion-conducting compound also exists on the surface of the dielectric layer 12 facing the cathode 13.

The salt is a compound in which a cation and an anion are bonded together to achieve electrical neutralization.

Examples of the cation include a lithium ion, sodium ion, potassium ion, calcium ion, magnesium ion, ammonium ion, imidazolium ion, alkylammonium ion or pyridinium ion.

Examples of the anion include a sulfate ion, sulfite ion, chloride ion, nitrate ion, nitrite ion, phosphate ion, phosphite ion, carboxylate ion, sulfonate ion, hydroxide ion or carbonate ion.

Specific examples of the salt include ammonium sulfate, ammonium 4-sulfophthalate, imidazolium 5-sulfoisophthalate, lithium 5-sulfoisophthalate, ammonium benzoate, sodium dodecylbenzenesulfonate, ammonium adipate, para-toluenesulfonic acid, ethylmethylimidazolium trifluoromethanesulfonate, ammonium trifluorosulfonate, diammonium phthalate, ditetraethylmethylammonium phthalate, ammonium succinate, tetramethylammonium maleate, methylethylimidazolium benzoate, triethanolammonium para-styrenesulfonate, triethylmethylammonium isophthalate, diethylethanolammonium para-toluenesulfonate, methylethylimidazolium 4-sulfophthalate, potassium hydroquinonesulfonate and ammonium 2,4-dihydroxybenzoate.

Of the above salts, in terms of maximizing the increase in the electrostatic capacitance and the reduction in the ESR, a salt of a nitrogen-containing cation and an anion is preferred, and an ammonium salt or imidazolium salt is particularly desirable.

Specific examples of ammonium salts include ammonium sulfate, ammonium 4-sulfophthalate, ammonium benzoate, ammonium adipate, ammonium trifluorosulfonate, diammonium phthalate, ditetraethylmethylammonium phthalate, ammonium succinate, tetramethylammonium maleate, triethanolammonium para-styrenesulfonate, triethylmethylammonium isophthalate, diethylethanolammonium para-toluenesulfonate and ammonium 2,4-dihydroxybenzoate.

Specific examples of imidazolium salts include imidazolium 5-sulfoisophthalate, ethylmethylimidazolium trifluoromethanesulfonate and methylethylimidazolium 4-sulfophthalate.

### <Cathode>

The cathode 13 includes a solid electrolyte layer 13a and a cathode conductive layer 13b composed of carbon, silver or aluminum or the like, which is formed on top of the solid electrolyte layer 13a.

### (Solid Electrolyte Layer)

The solid electrolyte layer 13a is a layer that contains a π-conjugated conductive polymer and a polyanion, and is formed on the dielectric layer 12 on the side of the cathode 13.

### [π-Conjugated Conductive Polymer]

The π-conjugated conductive polymer can use any organic polymer in which the main chain is composed of a π-conjugated system. Examples include polypyrroles, polythiophenes, polyacetylenes, polyphenylenes, polyphenylenevinylenes, polyanilines, polyacenes, polythiophenevinylenes, and copolymers thereof.

Specific examples of this type of π-conjugated conductive polymer include polypyrrole, poly(N-methylpyrrole), poly(3-methylpyrrole), poly(3-ethylpyrrole), poly(3-n-propylpyrrole), poly(3-butylpyrrole), poly(3-octylpyrrole), poly(3-decylpyrrole), poly(3-dodecylpyrrole), poly(3,4-dimethylpyrrole), poly(3,4-dibutylpyrrole), poly(3-carboxypyrrole), poly(3-methyl-4-carboxypyrrole), poly(3-methyl-4-carboxyethylpyrrole), poly(3-methyl-4-carboxybutylpyrrole), poly(3-hydroxypyrrole), poly(3-methoxypyrrole), poly(3-ethoxypyrrole), poly(3-butoxypyrrole), poly(3-hexyloxypyrrole), poly(3-methyl-4-hexyloxypyrrole), polythiophene, poly(3-methylthiophene), poly(3-ethylthiophene), poly(3-propylthiophene), poly(3-butylthiophene), poly(3-hexylthiophene), poly(3-heptylthiophene), poly(3-octylthiophene), poly(3-decylthiophene), poly(3-dodecylthiophene), poly(3-octadecylthiophene), poly(3-bromothiophene), poly(3-chlorothiophene), poly(3-iodothiophene), poly(3-cyanothiophene), poly(3-phenylthiophene), poly(3,4-dimethylthiophene), poly(3,4-dibutylthiophene), poly(3-hydroxythiophene), poly(3-methoxythiophene), poly(3-ethoxythiophene), poly(3-butoxythiophene), poly(3-hexyloxythiophene), poly(3-heptyloxythiophene), poly(3-octyloxythiophene), poly(3-decyloxythiophene), poly(3-dodecyloxythiophene), poly(3-octadecyloxythiophene), poly(3,4-dihydroxythiophene), poly(3,4-dimethoxythiophene), poly(3,4-diethoxythiophene), poly(3,4-dipropoxythiophene), poly(3,4-dibutoxythiophene), poly(3,4-dihexyloxythiophene), poly(3,4-diheptyloxythiophene), poly(3,4-dioctyloxythiophene), poly(3,4-didecyloxythiophene), poly(3,4-didodecyloxythiophene), poly(3,4-ethylenedioxythiophene), poly(3,4-propylenedioxythiophene), poly(3,4-butenedioxythiophene), poly(3-methyl-4-methoxythiophene), poly(3-methyl-4-ethoxythiophene), poly(3-carboxythiophene), poly(3-methyl-4-carboxythiophene), poly(3-methyl-4-carboxyethylthiophene), poly(3-methyl-4-carboxybutylthiophene), polyaniline, poly(2-methylaniline), poly(3-isobutylaniline), poly(2-anilinesulfonic acid), and poly(3-anilinesulfonic acid).

Of these, a (co)polymer composed of either one or two compounds selected from among polypyrrole, polythiophene, poly(N-methylpyrrole), poly(3-methylthiophene), poly(3-methoxythiophene) and poly(3,4-ethylenedioxythiophene) can be used particularly favorably in terms of the resistance and the reactivity. Moreover, polypyrrole and poly(3,4-ethylenedioxythiophene) yield a greater increase in conductivity and also offer improved heat resistance, and are therefore particularly desirable.

In order to ensure satisfactory manifestation of the function of the capacitor 10, the amount of the π-conjugated conductive polymer within the solid electrolyte layer 13a is preferably not less than 1% by mass, and is more preferably 5% by mass or greater.

### [Polyanion]

The polyanion is a homopolymer or copolymer selected from among substituted or unsubstituted polyalkylenes, substituted or unsubstituted polyalkenylenes, substituted or unsubstituted polyimides, substituted or unsubstituted polyamides and substituted or unsubstituted polyesters, and contains structural units having an anion group, and if required, structural units having no anion group.

The polyanion not only makes the π-conjugated conductive polymer soluble in the solvent, but also functions as a dopant for the π-conjugated conductive polymer.

The term “polyalkylene” describes a polymer in which the main chain is composed of repeating methylene units.

A “polyalkenylene” is a polymer composed of structural units having one or more unsaturated bonds (vinyl groups) within the main chain. Of these, substituted or unsubstituted butenylenes are preferred because they exhibit an interaction between the unsaturated bonds and the π-conjugated conductive polymer, and are readily synthesized using a substituted or unsubstituted butadiene as the starting material.

Examples of the polyimides include polyimides formed from an anhydride such as pyromellitic dianhydride, biphenyl tetracarboxylic dianhydride, benzophenone tetracarboxylic dianhydride, 2,2′,3,3′-tetracarboxydiphenyl ether dianhydride or 2,2′-[4,4′-di(dicarboxyphenyloxy)phenyl]propane dianhydride, and a diamine such as oxydiamine, para-phenylenediamine, meta-phenylenediamine or benzophenonediamine.

Examples of the polyamides include polyamide 6, polyamide 6,6 and polyamide 6,10 and the like.

Examples of the polyesters include polyethylene terephthalate and polybutylene terephthalate and the like.

In those cases where the polyanion includes substituents, examples of those substituents include alkyl groups, hydroxyl groups, amino groups, cyano groups, phenyl groups, phenol groups, ester groups, alkoxy groups and carbonyl groups. Considering factors such as the solubility of the polyanion in solvents, the heat resistance, and the compatibility of the polyanion with resins, alkyl groups, hydroxyl groups, phenol groups and ester groups are preferred.

Alkyl groups can improve the solubility and dispersibility of the polyanion in polar solvents or non-polar solvents, and can also improve the compatibility with, and dispersibility within resins, whereas hydroxyl groups can readily form hydrogen bonds with other hydrogen atoms or the like, thereby improving the solubility within organic solvents and the compatibility with, dispersibility within, and adhesion to resins. Moreover, cyano groups and hydroxyphenyl groups can improve the compatibility with, and solubility within polar resins, and can also enhance the heat resistance.

Of the above substituents, alkyl groups, hydroxyl groups, ester groups and cyano groups are preferred.

Examples of the alkyl groups include chain-like alkyl groups such as methyl, ethyl, propyl, butyl, isobutyl, t-butyl, pentyl, hexyl, octyl, decyl and dodecyl groups, and cycloalkyl groups such as cyclopropyl, cyclopentyl and cyclohexyl groups. Considering factors such as the solubility within organic solvents, the dispersibility within resins, and steric hindrance, alkyl groups of 1 to 12 carbon atoms are particularly preferred.

Examples of the hydroxyl groups include hydroxyl groups bonded directly to the main chain of the polyanion, and hydroxyl groups bonded to the main chain via other functional groups. Examples of these other functional groups include alkyl groups of 1 to 7 carbon atoms, alkenyl groups of 2 to 7 carbon atoms, amide groups and imide groups and the like. The hydroxyl groups may be substituted at either the terminal of these functional groups, or at non-terminal positions within the functional groups. Of these groups, hydroxyl groups bonded to the terminal of an alkyl group of 1 to 6 carbon atoms that is bonded to the main chain are particularly preferred in terms of the resulting compatibility with resins and solubility within organic solvents.

Examples of the ester groups include alkyl ester groups or aromatic ester groups bonded directly to the main chain of the polyanion, and alkyl ester groups or aromatic ester groups bonded to the main chain via other functional groups.

Examples of the cyano groups include cyano groups bonded directly to the main chain of the polyanion, cyano groups bonded to the terminal of an alkyl group of 1 to 7 carbon atoms that is bonded to the main chain of the polyanion, and cyano groups bonded to the terminal of an alkenyl group of 2 to 7 carbon atoms that is bonded to the main chain of the polyanion.

As the anion groups of the polyanion, any functional groups that are capable of causing the chemical oxidative doping of the π-conjugated conductive polymer may be used, but of such functional groups, from the viewpoints of the ease and stability of manufacture, mono-substituted sulfate ester groups, mono-substituted phosphate ester groups, phosphoric acid groups, carboxyl groups and sulfo groups and the like are preferred. Moreover, in terms of the doping effect of the functional groups on the π-conjugated conductive polymer, sulfo groups and mono-substituted sulfate ester groups are particularly desirable.

Specific examples of the polyanion include polyvinyl sulfonic acid, polystyrene sulfonic acid, polyallyl sulfonic acid, polyacryl sulfonic acid, polymethacryl sulfonic acid, poly(2-acrylamido-2-methylpropane sulfonic acid), polyisoprene sulfonic acid and polyacrylic acid. The polyanion may be either a homopolymer of one of these polymers, or a copolymer of two or more of the above polymers.

Of these, polyacryl sulfonic acid and polymethacryl sulfonic acid are able to alleviate thermal decomposition of the π-conjugated conductive polymer by absorbing thermal energy and undergoing self-decomposition. Accordingly, these polyanions exhibit excellent heat resistance and environmental resistance.

### [Conductivity Improver]

In order to enable a reduction in the ESR of the capacitor 10, the solid electrolyte layer 13a preferably also includes a conductivity improver that acts upon the π-conjugated conductive polymer to improve the conductivity of the solid electrolyte layer 13a.

Examples of the conductivity improver include nitrogen-containing aromatic cyclic compounds, compounds containing two or more hydroxyl groups, compounds containing two or more carboxyl groups, compounds containing one or more hydroxyl groups and one or more carboxyl groups, compounds containing an amide group, compounds containing an imide group, lactam compounds, compounds containing a glycidyl group, acrylic compounds, and water-soluble organic solvents.

Nitrogen-Containing Aromatic Cyclic Compounds

A “nitrogen-containing aromatic cyclic compound” is a compound having an aromatic ring that contains at least one nitrogen atom, in which the nitrogen atom within the aromatic ring has a conjugated relationship with another atom within the aromatic ring. In order to achieve this conjugated relationship, the nitrogen atom and the other atom form an unsaturated bond. Alternatively, the nitrogen atom may be positioned adjacent to another atom that forms part of an unsaturated bond, even if the nitrogen atom itself does not form an unsaturated bond directly with the other atom. This is because the unshared electron pair on the nitrogen atom is able to form a pseudo-conjugated relationship with the unsaturated bond formed between the other atoms.

The nitrogen-containing aromatic cyclic compound preferably includes both a nitrogen atom that has a conjugated relationship with another atom, and a nitrogen atom that is positioned adjacent to another atom that forms part of an unsaturated bond.

Examples of this type of nitrogen-containing aromatic cyclic compound include compounds containing a single nitrogen atom such as pyridines and derivatives thereof, compounds containing two nitrogen atoms such as imidazoles and derivatives thereof, pyrimidines and derivatives thereof, and pyrazines and derivatives thereof, and compounds containing three nitrogen atoms such as triazines and derivatives thereof. From the viewpoint of the solubility within solvents, pyridines and derivatives thereof, imidazoles and derivatives thereof, and pyrimidines and derivatives thereof are preferred.

Further, the nitrogen-containing aromatic cyclic compound may include a substituent such as an alkyl group, hydroxyl group, carboxyl group, cyano group, phenyl group, phenol group, oxycarbonyl group, alkoxy group or carbonyl group on the ring, or may be an unsubstituted compound. Furthermore, the ring may also be a polycyclic structure.

Specific examples of the pyridines and derivatives thereof include pyridine, 2-methylpyridine, 3-methylpyridine, 4-methylpyridine, 4-ethylpyridine, N-vinylpyridine, 2,4-dimethylpyridine, 2,4,6-trimethylpyridine, 3-cyano-5-methylpyridine, 2-pyridinecarboxylic acid, 6-methyl-2-pyridinecarboxylic acid, 4-pyridinecarboxaldehyde, 4-aminopyridine, 2,3-diaminopyridine, 2,6-diaminopyridine, 2,6-diamino-4-methylpyridine, 4-hydroxypyridine, 4-pyridinemethanol, 2,6-dihydroxypyridine, 2,6-pyridinedimethanol, methyl 6-hydroxynicotinate, 2-hydroxy-5-pyridinemethanol, ethyl 6-hydroxynicotinate, 4-pyridinemethanol, 4-pyridineethanol, 2-phenylpyridine, 3-methylquinoline, 3-ethylquinoline, quinolinol, 2,3-cyclopentenopyridine, 2,3-cyclohexanopyridine, 1,2-di(4-pyridyl)ethane, 1,2-di(4-pyridyl)propane, 2-pyridinecarboxaldehyde, 2-pyridinecarboxylic acid, 2-pyridinecarbonitrile, 2,3-pyridinedicarboxylic acid, 2,4-pyridinedicarboxylic acid, 2,5-pyridinedicarboxylic acid, 2,6-pyridinedicarboxylic acid and 3-pyridinesulfonic acid.

Specific examples of the imidazoles and derivatives thereof include imidazole, 2-methylimidazole, 2-propylimidazole, 2-undecylimidazole, 2-phenylimidazole, N-methylimidazole, N-vinylimidazole, N-allylimidazole, 1-(2-hydroxyethyl)imidazole (N-hydroxyethylimidazole), 2-ethyl-4-methylimidazole, 1,2-dimethylimidazole, 1-benzyl-2-methylimidazole, 1-benzyl-2-phenylimidazole, 1-cyanoethyl-2-methylimidazole, 1-cyanoethyl-2-ethyl-4-methylimidazole, 2-phenyl-4,5-dihydroxymethylimidazole, 1-acetylimidazole, 4,5-imidazoledicarboxylic acid, dimethyl 4,5-imidazoledicarboxylate, benzimidazole, 2-aminobenzimidazole, 2-aminobenzimidazole-2-sulfonic acid, 2-amino-1-methylbenzimidazole, 2-hydroxybenzimidazole and 2-(2-pyridyl)benzimidazole.

Specific examples of the pyrimidines and derivatives thereof include 2-amino-4-chloro-6-methylpyrimidine, 2-amino-6-chloro-4-methoxypyrimidine, 2-amino-4,6-dichloropyrimidine, 2-amino-4,6-dihydroxypyrimidine, 2-amino-4,6-dimethylpyrimidine, 2-amino-4,6-dimethoxypyrimidine, 2-aminopyrimidine, 2-amino-4-methylpyrimidine, 4,6-dihydroxypyrimidine, 2,4-dihydroxypyrimidine-5-carboxylic acid, 2,4,6-triaminopyrimidine, 2,4-dimethoxypyrimidine, 2,4,5-trihydroxypyrimidine and 2,4-pyrimidinediol.

Specific examples of the pyrazines and derivatives thereof include pyrazine, 2-methylpyrazine, 2,5-dimethylpyrazine, pyrazinecarboxylic acid, 2,3-pyrazinedicarboxylic acid, 5-methylpyrazinecarboxylic acid, pyrazinamide, 5-methylpyrazinamide, 2-cyanopyrazine, aminopyrazine, 3-aminopyrazine-2-carboxylic acid, 2-ethyl-3-methylpyrazine, 2,3-dimethylpyrazine and 2,3-diethylpyrazine.

Specific examples of the triazines and derivatives thereof include 1,3,5-triazine, 2-amino-1,3,5-triazine, 3-amino-1,2,4-triazine, 2,4-diamino-6-phenyl-1,3,5-triazine, 2,4,6-triamino-1,3,5-triazine, 2,4,6-tris(trifluoromethyl)-1,3,5-triazine, 2,4,6-tri-2-pyridine-1,3,5-triazine, 3-(2-pyridine)-5,6-bis(4-phenylsulfonic acid)-1,2,4-triazinedisodium, 3-(2-pyridine)-5,6-diphenyl-1,2,4-triazine, 3-(2-pyridine)-5,6-diphenyl-1,2,4-triazine-ρ,ρ′-disodiumdisulfonate and 2-hydroxy-4,6-dichloro-1,3,5-triazine.

Because the nitrogen atom in the nitrogen-containing aromatic cyclic compound contains an unshared electron pair, a substituent or a proton can readily coordinate or bond to the nitrogen atom. When a substituent or a proton coordinates or bonds to the nitrogen atom, the nitrogen atom tends to adopt a cationic charge. Because the nitrogen atom has a conjugated relationship with another atom, the cationic charge generated as a result of the coordination or bonding of the substituent or proton to the nitrogen atom is dispersed throughout the nitrogen-containing aromatic ring, and exists in a stable manner.

For this reason, the nitrogen-containing aromatic cyclic compound may form a nitrogen-containing aromatic cyclic compound cation with a substituent introduced at the nitrogen atom. Further, the cation and an anion may be combined to form a salt. Even in the form of a salt, the same effect is achieved as that provided by a non-cationic form of the nitrogen-containing aromatic cyclic compound.

Examples of the substituent that may be introduced at the nitrogen atom of the nitrogen-containing aromatic cyclic compound include a hydrogen atom, or an alkyl group, hydroxyl group, carboxyl group, cyano group, phenyl group, phenol group, oxycarbonyl group, alkoxy group, or carbonyl group. The type of substituent that is introduced may be any of the substituents described above.

The amount of the nitrogen-containing aromatic cyclic compound is preferably within a range from 0.1 to 100 mols, and more preferably from 0.5 to 30 mols, per 1 mol of anionic group units within the polyanion. From the viewpoints of the physical properties and conductivity of the solid electrolyte layer 13a, this amount is most preferably within a range from 1 to 10 mols. If the amount of the nitrogen-containing aromatic cyclic compound is less than 0.1 mols, then the interaction between the nitrogen-containing aromatic cyclic compound and the polyanion and π-conjugated conductive polymer tends to weaken, and the resulting conductivity may be inadequate. In contrast, if the amount of the nitrogen-containing aromatic cyclic compound exceeds 100 mols, then the amount of the π-conjugated conductive polymer is reduced, which makes it difficult to achieve a satisfactory degree of conductivity, and may alter the physical properties of the solid electrolyte layer 13a.

Compounds Containing Two or More Hydroxyl Groups

Examples of the compound containing two or more hydroxyl groups include polyhydric aliphatic alcohols such as propylene glycol, 1,3-butylene glycol, 1,4-butylene glycol, glycerol, diglycerol, D-glucose, D-glucitol, isoprene glycol, dimethylolpropionic acid, butanediol, 1,5-pentanediol, 1,6-hexanediol, 1,9-nonanediol, neopentyl glycol, trimethylolethane, trimethylolpropane, pentaerythritol, dipentaerythritol, thiodiethanol, glucose, tartaric acid, D-glucaric acid and glutaconic acid;

polymer alcohols such as polyvinyl alcohol, cellulose, polysaccharides and sugar alcohols;

aromatic compounds such as 1,4-dihydroxybenzene, 1,3-dihydroxybenzene, 2,3-dihydroxy-1-pentadecylbenzene, 2,4-dihydroxyacetophenone, 2,5-dihydroxyacetophenone, 2,4-dihydroxybenzophenone, 2,6-dihydroxybenzophenone, 3,4-dihydroxybenzophenone, 3,5-dihydroxybenzophenone, 2,4′-dihydroxydiphenylsulfone, 2,2′,5,5′-tetrahydroxydiphenylsulfone, 3,3′,5,5′-tetramethyl-4,4′-dihydroxydiphenylsulfone, hydroxyquinonecarboxylic acid and salts thereof, 2,3-dihydroxybenzoic acid, 2,4-dihydroxybenzoic acid, 2,5-dihydroxybenzoic acid, 2,6-dihydroxybenzoic acid, 3,5-dihydroxybenzoic acid, 1,4-hydroquinonesulfonic acid and salts thereof, 4,5-hydroxybenzene-1,3-disulfonic acid and salts thereof, 1,5-dihydroxynaphthalene, 1,6-dihydroxynaphthalene, 2,6-dihydroxynaphthalene, 2,7-dihydroxynaphthalene, 2,3-dihydroxynaphthalene, 1,5-dihydroxynaphthalene-2,6-dicarboxylic acid, 1,6-dihydroxynaphthalene-2,5-dicarboxylic acid, 1,5-dihydroxynaphthoic acid, phenyl 1,4-dihydroxy-2-naphthoate, 4,5-dihydroxynaphthalene-2,7-disulfonic acid and salts thereof, 1,8-dihydroxy-3,6-naphthalenedisulfonic acid and salts thereof, 6,7-dihydroxy-2-naphthalenesulfonic acid and salts thereof, 1,2,3-trihydroxybenzene (pyrogallol), 1,2,4-trihydroxybenzene, 5-methyl-1,2,3-trihydroxybenzene, 5-ethyl-1,2,3-trihydroxybenzene, 5-propyl-1,2,3-trihydroxybenzene, trihydroxybenzoic acid, trihydroxyacetophenone, trihydroxybenzophenone, trihydroxybenzaldehyde, trihydroxyanthraquinone, 2,4,6-trihydroxybenzene, tetrahydroxy-p-benzoquinone, tetrahydroxyanthraquinone, methyl gallate and ethyl gallate; and potassium hydroquinone sulfonate.

The amount of the compound containing two or more hydroxyl groups is preferably within a range from 0.05 to 50 mols, and more preferably from 0.3 to 10 mols, per 1 mol of anionic group units within the polyanion. If the amount of the compound containing two or more hydroxyl groups is less than 0.05 mols per 1 mol of anionic group units within the polyanion, then the resulting conductivity and heat resistance may be inadequate. In contrast, if the amount of the compound containing two or more hydroxyl groups exceeds 50 mols per 1 mol of anionic group units within the polyanion, then the amount of the π-conjugated conductive polymer within the solid electrolyte layer 13a is reduced, which makes it difficult to achieve a satisfactory degree of conductivity, and may alter the physical properties of the solid electrolyte layer 13a.

In those cases where a compound containing two or more hydroxyl groups is included as a conductivity improver, the conductivity of the solid electrolyte layer 13a can be further improved for the following reasons.

Namely, because the π-conjugated conductive polymer within the solid electrolyte layer 13a is in a state of high-level oxidation, heat and the like can readily cause oxidative degradation of a portion of the π-conjugated conductive polymer. As a result, it is thought that radicals are generated, and degradation can then proceed via radical chain formation. However, it is surmised that the compound containing two or more hydroxyl groups is able to trap these radicals via the hydroxyl groups, thereby blocking the formation of radical chains and inhibiting any degradation from proceeding, resulting in improved conductivity.

Compounds Containing Two or More Carboxyl Groups

Examples of the compound containing two or more carboxyl groups include aliphatic carboxylic acid compounds such as maleic acid, fumaric acid, itaconic acid, citraconic acid, malonic acid, 1,4-butanedicarboxylic acid, succinic acid, tartaric acid, adipic acid, D-glucaric acid, glutaconic acid and citric acid;

aromatic carboxylic acid compounds containing at least one carboxyl group bonded to an aromatic ring, such as phthalic acid, terephthalic acid, isophthalic acid, tetrahydrophthalic anhydride, 5-sulfoisophthalic acid, 5-hydroxyisophthalic acid, methyltetrahydrophthalic anhydride, 4,4′-oxydiphthalic acid, biphenyltetracarboxylic dianhydride, benzophenonetetracarboxylic dianhydride, naphthalenedicarboxylic acid, trimellitic acid and pyromellitic acid; as well as diglycolic acid, oxydibutyric acid, thiodiacetic acid, thiodibutyric acid, iminodiacetic acid and iminobutyric acid.

The amount of the compound containing two or more carboxyl groups is preferably within a range from 0.1 to 30 mols, and more preferably from 0.3 to 10 mols, per 1 mol of anionic group units within the polyanion. If the amount of the compound containing two or more carboxyl groups is less than 0.1 mols per 1 mol of anionic group units within the polyanion, then the resulting conductivity and heat resistance may be inadequate. In contrast, if the amount of the compound containing two or more carboxyl groups exceeds 30 mols per 1 mol of anionic group units within the polyanion, then the amount of the π-conjugated conductive polymer within the solid electrolyte layer 13a is reduced, which makes it difficult to achieve a satisfactory degree of conductivity, and may alter the physical properties of the solid electrolyte layer 13a.

Compounds Containing One or More Hydroxyl Groups and One or More Carboxyl Groups

Examples of the compound containing one or more hydroxyl groups and one or more carboxyl groups include tartaric acid, glyceric acid, dimethylolbutanoic acid, dimethylolpropanoic acid, D-glucaric acid and glutaconic acid.

The amount of the compound containing one or more hydroxyl groups and one or more carboxyl groups is preferably within a range from 1 to 5,000 parts by mass, and more preferably from 50 to 500 parts by mass, per 100 parts by mass of the combination of the polyanion and the π-conjugated conductive polymer. If the amount of the compound containing one or more hydroxyl groups and one or more carboxyl groups is less than 1 part by mass, then the resulting conductivity and heat resistance may be inadequate. In contrast, if the amount of the compound containing one or more hydroxyl groups and one or more carboxyl groups exceeds 5,000 parts by mass, then the amount of the π-conjugated conductive polymer within the solid electrolyte layer 13a is reduced, making it difficult to achieve a satisfactory degree of conductivity.

Amide Compounds

The compound containing an amide group refers to monomolecular compounds containing an amide linkage represented by —CO—NH— (wherein the CO portion includes a double bond) within the molecule. In other words, examples of the amide compounds include compounds having a functional group at both terminals of the above amide linkage, compounds having a cyclic compound bonded to one terminal of the above linkage, urea, in which the functional groups at both terminals are hydrogen atoms, and urea derivatives.

Specific examples of the amide compound include acetamide, malonamide, succinamide, maleamide, fumaramide, benzamide, naphthamide, phthalamide, isophthalamide, terephthalamide, nicotinamide, isonicotinamide, 2-furamide, formamide, N-methylformamide, propionamide, propiolamide, butyramide, isobutyramide, methacrylamide, palmitamide, stearamide, oleamide, oxamide, glutaramide, adipamide, cinnamamide, glucolamide, lactamide, glyceramide, tartaramide, citramide, glyoxylamide, pyruvamide, acetoacetamide, dimethylacetamide, benzylamide, anthranylamide, ethylenediaminetetraacetamide, diacetamide, triacetamide, dibenzamide, tribenzamide, rhodanine, urea, 1-acetyl-2-thiourea, biuret, butylurea, dibutylurea, 1,3-dimethylurea, 1,3-diethylurea, and derivatives thereof.

Furthermore, acrylamides may also be used as amide compound. Specific examples of these acrylamides include N-methylacrylamide, N-methylmethacrylamide, N-ethylacrylamide, N-ethylmethacrylamide, N,N-dimethylacrylamide, N,N-dimethylmethacrylamide, N,N-diethylacrylamide, N,N-diethylmethacrylamide, 2-hydroxyethylacrylamide, 2-hydroxyethylmethacrylamide, N-methylolacrylamide and N-methylolmethacrylamide.

The molecular weight of the amide compound is preferably within a range from 46 to 10,000, more preferably from 46 to 5,000, and still more preferably from 46 to 1,000.

The amount of the amide compound is preferably within a range from 1 to 5,000 parts by mass, and more preferably from 50 to 500 parts by mass, per 100 parts by mass of the combination of the polyanion and the π-conjugated conductive polymer. If the amount of the amide compound is less than 1 part by mass, then the conductivity and the heat resistance may be inadequate. Further, if the amount of the amide compound exceeds 5,000 parts by mass, then the amount of the π-conjugated conductive polymer within the solid electrolyte layer 13a is reduced, making it difficult to achieve a satisfactory degree of conductivity.

Imide Compounds

As the amide compound, a monomolecular compound containing an imide linkage (hereafter referred to as an imide compound) is preferred, as it yields a greater improvement in the conductivity. Examples of the imide compound, described in terms of the molecular skeleton, include phthalimide and phthalimide derivatives, succinimide and succinimide derivatives, benzimide and benzimide derivatives, maleimide and maleimide derivatives, and naphthalimide and naphthalimide derivatives.

Further, the imide compounds are classified as either aliphatic imides or aromatic imides or the like on the basis of the functional groups at the two terminals, and from the viewpoint of solubility, aliphatic imides are preferred.

Moreover, aliphatic imide compounds can be classified into saturated aliphatic imide compounds, which contain one or more unsaturated bonds between the carbon atoms within the molecule, and unsaturated aliphatic imide compounds, which contain one or more unsaturated bonds between the carbon atoms within the molecule.

Saturated aliphatic imide compounds are compounds represented by the formula: R¹—CO—NH—CO—R², wherein R¹ and R² are both saturated hydrocarbon groups. Specific examples include cyclohexane-1,2-dicarboximide, allantoin, hydantoin, barbituric acid, alloxan, glutarimide, succinimide, 5-butylhydantoic acid, 5,5-dimethylhydantoin, 1-methylhydantoin, 1,5,5-trimethylhydantoin, 5-hydantoinacetic acid, N-hydroxy-5-norbornene-2,3-dicarboximide, semicarbazide, α,α-dimethyl-6-methylsuccinimide, bis[2-(succinimidooxycarbonyloxy)ethyl]sulfone, α-methyl-α-propylsuccinimide and cyclohexylimide.

Unsaturated aliphatic imide compounds are compounds represented by the formula: R¹—CO—NH—CO—R², wherein either one of, or both, R¹ and R² contain one or more unsaturated bonds. Specific examples include 1,3-dipropyleneurea, maleimide, N-methylmaleimide, N-ethylmaleimide, N-hydroxymaleimide, 1,4-bismaleimidobutane, 1,6-bismaleimidohexane, 1,8-bismaleimidooctane and N-carboxheptylmaleimide.

The molecular weight of the imide compound is preferably within a range from 60 to 5,000, more preferably from 70 to 1,000, and still more preferably from 80 to 500.

The amount of the imide compound is preferably within a range from 10 to 10,000 parts by mass, and more preferably from 50 to 5,000 parts by mass, per 100 parts by mass of the combination of the π-conjugated conductive polymer and the polyanion. If the amounts of the amide compound and the imide compound are less than the lower limits of the respective ranges mentioned above, then the effects achieved by adding the amide compound and/or the imide compound tend to diminish, which is undesirable. In contrast, if the amounts exceed the upper limits of the respective ranges, then the conductivity tends to decrease as a result of a reduction in the concentration of the π-conjugated conductive polymer, which is also undesirable.

Lactam Compounds

A lactam compound is an intramolecular cyclic amide of an aminocarboxylic acid, and is a compound in which a portion of the ring can be represented by —CO—NR— (wherein R is a hydrogen atom or an arbitrary substituent). One or more of the carbon atoms within the ring may be unsaturated or substituted for a hetero atom.

Examples of the lactam compound include pentano-4-lactam, 4-pentanelactam-5-methyl-2-pyrrolidone, 5-methyl-2-pyrrolidinone, hexano-6-lactam, and 6-hexanelactam.

The amount of the lactam compound is preferably within a range from 10 to 10,000 parts by mass, and more preferably from 50 to 5,000 parts by mass, per 100 parts by mass of the combination of the π-conjugated conductive polymer and the polyanion. If the amount added of the lactam compound is less than the lower limit of the above range, then the effects achieved by adding the lactam compound tend to diminish, which is undesirable. In contrast, if the amount exceeds the upper limit of the above range, then the conductivity tends to decrease as a result of the reduction in the concentration of the π-conjugated conductive polymer, which is also undesirable.

Compounds Containing a Glycidyl Group

Examples of the compound containing a glycidyl group include glycidyl compounds such as ethyl glycidyl ether, butyl glycidyl ether, t-butyl glycidyl ether, allyl glycidyl ether, benzyl glycidyl ether, glycidyl phenyl ether, bisphenol A, diglycidyl ether, glycidyl ether acrylate and glycidyl ether methacrylate.

The amount of the compound containing a glycidyl group is preferably within a range from 10 to 10,000 parts by mass, and more preferably from 50 to 5,000 parts by mass, per 100 parts by mass of the combination of the π-conjugated conductive polymer and the polyanion. If the amount added of the compound containing a glycidyl group is less than the lower limit of the above range, then the effects achieved by adding the compound containing a glycidyl group tend to diminish, which is undesirable. In contrast, if the amount exceeds the upper limit of the above range, then the conductivity tends to decrease as a result of the reduction in the concentration of the π-conjugated conductive polymer, which is also undesirable.

Acrylic Compounds

Examples of the acrylic compound include acrylic acid, monofunctional (meth)acrylate compounds such as 2-hydroxyethyl methacrylate, 2-hydroxypropyl methacrylate, n-butoxyethyl methacrylate, n-butoxyethylene glycol methacrylate, methoxytriethylene glycol methacrylate, methoxypolyethylene glycol methacrylate, 2-hydroxyethyl acrylate, 2-hydroxypropyl acrylate, n-butoxyethyl acrylate, n-butoxyethylene glycol acrylate, methoxytriethylene glycol acrylate and methoxypolyethylene glycol acrylate, difunctional (meth)acrylates such as ethylene glycol di(meth)acrylate, diethylene glycol di(meth)acrylate, triethylene glycol di(meth)acrylate, polyethylene glycol di(meth)acrylate, neopentyl glycol di(meth)acrylate and glycerol di(meth)acrylate, glycidyl ethers such as ethylene glycol diglycidyl ether, glycidyl ether, diethylene glycol diglycidyl ether, triethylene glycol diglycidyl ether, polyethylene glycol diglycidyl ether, propylene glycidyl ether, tripropylene glycidyl ether, polypropylene glycidyl ether and glycerol diglycidyl ether, as well as 2-methacryloyloxyethylsuccinic acid, glycidyl methacrylate, trimethylolpropane triacrylate, ethylene oxide-modified trimethylolpropane triacrylate, ethylene oxide-modified pentaerythritol triacrylate and ethylene oxide-modified pentaerythritol tetraacrylate.

The amount of the acrylic compound is preferably within a range from 10 to 10,000 parts by mass, and more preferably from 50 to 10,000 parts by mass, per 100 parts by mass of the combination of the π-conjugated conductive polymer and the polyanion. If the amount added of the acrylic compound is less than the lower limit of the above range, then the effects achieved by adding the acrylic compound tend to diminish, which is undesirable. In contrast, if the amount exceeds the upper limit of the above range, then the conductivity tends to decrease as a result of the reduction in the concentration of the π-conjugated conductive polymer, which is also undesirable.

Water-Soluble Organic Solvents

Examples of the water-soluble organic solvent include polar solvents such as N-methyl-2-pyrrolidone, N-methylacetamide, N,N-dimethylformamide, N,N-dimethylacetamide, dimethylsulfoxide, hexamethylenephosphortriamide, N-vinylpyrrolidone, N-vinylformamide and N-vinylacetamide, phenols such as cresol, phenol and xylenol, polyhydric aliphatic alcohols such as ethylene glycol, diethylene glycol, triethylene glycol, propylene glycol, dipropylene glycol, 1,3-butylene glycol, 1,4-butylene glycol, glycerol, diglycerol, D-glucose, D-glucitol, isoprene glycol, butanediol, 1,5-pentanediol, 1,6-hexanediol, 1,9-nonanediol and neopentyl glycol, carbonate compounds such as ethylene carbonate and propylene carbonate, ether compounds such as dioxane and diethyl ether, chain-like ethers such as dialkyl ethers, propylene glycol dialkyl ethers, polyethylene glycol dialkyl ethers and polypropylene glycol dialkyl ethers, heterocyclic compounds such as 3-methyl-2-oxazolidinone, and nitrile compounds such as acetonitrile, glutarodinitrile, methoxyacetonitrile, propionitrile and benzonitrile. These solvents may be used either individually, or as mixtures containing two or more different solvents.

### [Dopant]

In order to further improve the conductivity of the π-conjugated conductive polymer, the solid electrolyte layer 13a may also include other dopants besides the polyanion.

As these other dopants, halogen compounds, Lewis acids, and protic acids and the like can be used, and specific examples include organic acids such as organic carboxylic acids and organic sulfonic acids, as well as organic cyano compounds, fullerene, fullerene hydride, fullerene hydroxide, fullerene carboxylate and fullerene sulfonate.

Specific examples of the organic acids include alkylbenzenesulfonic acids, alkylnaphthalenesulfonic acids, alkylnaphthalenedisulfonic acids, naphthalenesulfonic acid-formalin polycondensates, melaminesulfonic acid-formalin polycondensates, naphthalenedisulfonic acid, naphthalenetrisulfonic acid, dinaphthylmethanedisulfonic acid, anthraquinonesulfonic acid, anthraquinonedisulfonic acid, anthracenesulfonic acid, pyrenesulfonic acid, acetic acid, oxalic acid, benzoic acid, phthalic acid, maleic acid, fumaric acid and malonic acid. Further, metal salts of these organic acids may also be used.

As the organic cyano compound, compounds having two or more cyano groups bonded to a conjugated bond may be used. Specific examples include tetracyanoethylene, tetracyanoethylene oxide, tetracyanobenzene, dichlorodicyanobenzoquinone (DDQ), tetracyanoquinodimethane and tetracyanoazanaphthalene.

The ratio between the π-conjugated conductive polymer and the dopant, reported as a molar ratio, is preferably within a range from π-conjugated conductive polymer:dopant=97:3 to 10:90. The conductivity tends to deteriorate if the amount of the dopant is either higher or lower than this range.

If required, the solid electrolyte layer 13a may also include a polymer component, surfactant, dispersant or silane coupling agent or the like.

### (Cathode Conductive Layer)

The cathode conductive layer 13b of the cathode 13 is formed, for example, from carbon, silver or aluminum or the like. A cathode conductive layer 13b formed from carbon or silver or the like can be formed from a conductive paste containing a conductor such as carbon or silver. Further, a cathode conductive layer 13b formed from aluminum may be formed from an aluminum foil.

If required, a separator may be provided between the dielectric layer 12 and the cathode conductive layer 13b.

In the capacitor 10 described above, the solid electrolyte layer 13a is formed on the surface of the dielectric layer 12 that has been treated with a salt and therefore exhibits an enhanced affinity for the π-conjugated conductive polymer. In this type of capacitor 10, the π-conjugated conductive polymer is able to penetrate deeply into the interior of the dielectric layer 12, meaning an increased capacitance can be realized.

Further, performing the treatment with a salt increases the contact surface area at the interface between the dielectric layer 12 and the solid electrolyte layer 13a, enabling the ESR of the capacitor 10 to be reduced.

### [Method of Producing Capacitor]

Next is a description of an embodiment of the method of producing a capacitor according to the present invention.

### <Dielectric Layer Formation Step>

In the method of producing the capacitor 10 according to the present embodiment, first, in a dielectric layer formation step, the surface of the anode 11 formed from a valve metal is oxidized to form the dielectric layer 12.

Examples of the method used for oxidizing the surface of the anode 11 include a method in which the surface of the anode 11 is subjected to anodic oxidation within an electrolyte such as an aqueous solution of ammonium adipate.

### <Salt Treatment Step>

Subsequently, in a salt treatment step, the surface of the dielectric layer 12 is treated with a treatment liquid containing a salt and a solvent.

Examples of methods that may be used for treating the surface of the dielectric layer 12 with the treatment liquid containing a salt include methods in which the treatment liquid is applied to the surface of the dielectric layer 12 using conventional coating, dipping or spraying methods.

### (Treatment Liquid)

The pH of the treatment liquid is preferably within a range from 3 to 12, and more preferably from 4 to 10.

If the pH of the treatment liquid is less than 3 or greater than 12, then the dielectric layer 12 or the members that constitute the capacitor 10 may undergo corrosion. The pH of the treatment liquid may be adjusted by appropriate addition of conventional acidic compounds or alkaline compounds.

The treatment liquid preferably includes a conductivity improver described above, as this enables the ESR of the capacitor to be further reduced.

The solvent included in the treatment liquid is selected so as to dissolve the salt. As the solvent, water and/or an organic solvent may be used. Examples of the organic solvent include polar solvents such as N-methyl-2-pyrrolidone, N,N-dimethylformamide, N,N-dimethylacetamide, dimethylsulfoxide, hexamethylenephosphortriamide, N-vinylpyrrolidone, N-vinylformamide and N-vinylacetamide, phenols such as cresol, phenol and xylenol, alcohols such as methanol, ethanol, propanol and butanol, polyhydric aliphatic alcohols such as ethylene glycol, diethylene glycol, triethylene glycol, propylene glycol, dipropylene glycol, 1,3-butylene glycol, 1,4-butylene glycol, glycerol, diglycerol, D-glucose, D-glucitol, isoprene glycol, butanediol, 1,5-pentanediol, 1,6-hexanediol, 1,9-nonanediol and neopentyl glycol, ketones such as acetone and methyl ethyl ketone, hydrocarbons such as hexane, benzene and toluene, carboxylic acids such as formic acid and acetic acid, carbonate compounds such as ethylene carbonate and propylene carbonate, ether compounds such as dioxane and diethyl ether, chain-like ethers such as ethylene glycol dialkyl ethers, propylene glycol dialkyl ethers, polyethylene glycol dialkyl ethers and polypropylene glycol dialkyl ethers, heterocyclic compounds such as 3-methyl-2-oxazolidinone, and nitrile compounds such as acetonitrile, glutarodinitrile, methoxyacetonitrile, propionitrile and benzonitrile. These solvents may be used either individually, as mixtures containing two or more of the above solvents, or as mixtures with other solvents.

Of the above solvents, water and alcohol-based solvents are preferred due to their minimal environmental impact.

The salt concentration of the treatment liquid is preferably within a range from 0.1 to 90% by mass, and is more preferably from 0.3 to 50% by mass. Provided the salt concentration is at least as large as the lower limit of the above range, an increased capacitance can be achieved with good reliability, whereas a concentration that is not higher than the upper limit of the above range yields a treatment liquid that is easier to apply, and also enables a further reduction in the ESR.

### [Ion-Conducting Compound]

The treatment liquid preferably includes an ion-conducting compound that exhibits ion conductivity in the presence of the electrolyte, as this enables a further reduction in the ESR of the capacitor 10.

Examples of the ion-conducting compound include compounds having a polyether skeleton, (meth)acrylic compounds containing one or more hydroxyl groups, (meth)acrylic compounds containing one or more alkoxy groups, and compounds containing one or more epoxy groups. Of these, compounds having a polyether skeleton and (meth)acrylic compounds containing one or more hydroxyl groups have a greater effect in terms of reducing the ESR, and are consequently preferred.

The term “(meth)acrylic” is a generic term that includes both “acrylic” and “methacrylic”.

Examples of the compounds having a polyether skeleton include diethylene glycol, triethylene glycol, oligoethylene glycol, triethylene glycol monochlorohydrin, diethylene glycol monochlorohydrin, oligoethylene glycol monochlorohydrin, triethylene glycol monobromohydrin, diethylene glycol monobromohydrin, oligoethylene glycol monobromohydrin, polyethylene glycol, polyether, polyethylene oxide, triethylene glycol dimethyl ether, tetraethylene glycol dimethyl ether, diethylene glycol dimethyl ether, diethylene glycol diethyl ether, diethylene glycol dibutyl ether, dipropylene glycol, tripropylene glycol, polypropylene glycol, polypropylene dioxide, polyoxyethylene alkyl ethers, polyoxyethylene glycerol fatty acid esters, and polyoxyethylene fatty acid amides, ethylene glycol di(meth)acrylate, diethylene glycol di(meth)acrylate, triethylene glycol di(meth)acrylate, polyethylene glycol di(meth)acrylate, neopentyl glycol di(meth)acrylate, ethylene oxide-modified trimethylolpropane triacrylate, ethylene oxide-modified pentaerythritol triacrylate and ethylene oxide-modified pentaerythritol tetraacrylate.

Furthermore, of the (meth)acrylic compounds containing one or more hydroxyl groups, compounds containing one or more alkoxy groups, and compounds containing one or more epoxy groups described below, those compounds that have a polyether skeleton may also be classified as compounds having a polyether skeleton.

Examples of the (meth)acrylic compounds containing one or more hydroxyl groups include 2-hydroxyethyl methacrylate, 2-hydroxypropyl methacrylate, 2-hydroxyethyl acrylate, 2-hydroxypropyl acrylate and glycerol di(meth)acrylate.

Examples of the (meth)acrylic compounds containing one or more alkoxy groups include n-butoxyethyl methacrylate, n-butoxyethylene glycol methacrylate, methoxytriethylene glycol methacrylate, methoxypolyethylene glycol methacrylate, n-butoxyethyl acrylate, n-butoxyethylene glycol acrylate, methoxytriethylene glycol acrylate and methoxypolyethylene glycol acrylate.

Examples of the compounds containing one or more epoxy groups include glycidyl ethers such as ethylene glycol diglycidyl ether, glycidyl ether, diethylene glycol diglycidyl ether, triethylene glycol diglycidyl ether, polyethylene glycol diglycidyl ether, propylene glycol diglycidyl ether, tripropylene glycol diglycidyl ether, polypropylene glycol diglycidyl ether and glycerol diglycidyl ether, as well as glycidyl methacrylate.

Further, other compounds including glycerols (such as glycerol and diglycerol), acrylamide, polyvinylpyrrolidone, polyacrylamide, polyvinylacetamide, polyamide, polyimide, polyamic acid, polyacrylonitrile, polysilamine, polyvinyl alcohol and polyvinylphenol may also be used as the ion-conducting compound.

Furthermore, the compounds containing two or more hydroxyl groups listed above as conductivity improvers may also be used as the ion-conducting compound.

The amount of the ion-conducting compound is preferably within a range from 1 to 10,000 parts by mass, and more preferably from 50 to 1,500 parts by mass, per 100 parts by mass of the combination of the π-conjugated conductive polymer and the polyanion. If the amount of the ion-conducting compound is less than 1 part by mass, then the ESR of the capacitor 10 may not be reduced, whereas if the amount exceeds 10,000 parts by mass, then the conductivity of the solid electrolyte layer 13a tends to decrease, resulting in an increase in the ESR of the capacitor 10.

### [Alkaline Compound]

In terms of reducing the ESR of the capacitor 10, the treatment liquid preferably contains an alkaline compound.

Conventional inorganic alkali compounds or organic alkali compounds can be used as this alkaline compound. Examples of inorganic alkali compounds include sodium hydroxide, potassium hydroxide, calcium hydroxide and ammonia.

As the organic alkali compound, nitrogen-containing aromatic cyclic compounds (aromatic amines), aliphatic amines and metal alkoxides and the like can be used favorably.

Examples of the nitrogen-containing aromatic cyclic compounds include the compounds listed above.

Examples of the aliphatic amine compounds include ethylamine, n-octylamine, diethylamine, diisobutylamine, methylethylamine, trimethylamine, triethylamine, allylamine, 2-ethylaminoethanol, 2,2′-iminodiethanol and N-ethylethylenediamine.

Examples of the metal alkoxides include sodium alkoxides such as sodium methoxide and sodium ethoxide, as well as potassium alkoxides and calcium alkoxides.

### <Solid Electrolyte Formation Step>

Subsequently, in a solid electrolyte layer formation step, the solid electrolyte layer 13a is formed by applying a conductive polymer solution containing a π-conjugated conductive polymer, a polyanion and a solvent to the surface of the salt-treated dielectric layer 12.

Examples of the method used for applying the conductive polymer solution include a method in which the conductive polymer solution is applied to the surface of the dielectric layer 12 using a conventional coating device, a method in which the conductive polymer solution is sprayed onto the surface of the dielectric layer 12 using a conventional spray device, and a method in which the element including the dielectric layer 12 is dipped in the conductive polymer solution. Further, if required, the application may be performed under reduced pressure.

Following application of the conductive polymer solution, the solution is preferably dried using a conventional drying method such as hot air drying.

The conductive polymer solution can be obtained by subjecting a precursor monomer to the π-conjugated conductive polymer to polymerization in the presence of the polyanion and a solvent.

In a specific example of subjecting a precursor monomer to the π-conjugated conductive polymer to polymerization in the presence of the polyanion, the polyanion is first dissolved in a solvent capable of dissolving the polyanion, and the precursor monomer to the π-conjugated conductive polymer is then added to the resulting solution. Subsequently, an oxidant is added, the precursor monomer is polymerized, and the crude product is purified by removing any excess oxidant and precursor monomer, thus yielding the conductive polymer solution.

By conducting the polymerization in this manner, the π-conjugated conductive polymer grows in such as a manner as to form a salt with the polyanion. Accordingly, the resulting π-conjugated conductive polymer forms a complex with the polyanion.

Examples of the precursor monomer to the π-conjugated conductive polymer include pyrroles and derivatives thereof, thiophenes and derivatives thereof, and anilines and derivatives thereof.

As the oxidant, any compound capable of oxidizing the precursor monomer to form the π-conjugated conductive polymer may be used, and specific examples include peroxodisulfates such as ammonium peroxodisulfate (ammonium persulfate), sodium peroxodisulfate (sodium persulfate) and potassium peroxodisulfate (potassium persulfate), transition metal compounds such as ferric chloride, ferric sulfate, ferric nitrate and cupric chloride, metal halide compounds such as boron trifluoride and aluminum chloride, metal oxides such as silver oxide and cesium oxide, peroxides such as hydrogen peroxide and ozone, organic peroxides such as benzoyl peroxide, and oxygen and the like.

There are no particular restrictions on the solvent used in producing the π-conjugated conductive polymer, and any solvent capable of dissolving or dispersing the aforementioned precursor monomer, and also able to retain the oxidizing power of the oxidant may be used. Specific examples include the same solvents as those contained within the treatment liquid.

The method of producing the π-conjugated conductive polymer described above yields a solution of the π-conjugated conductive polymer having an acidic pH, but this tends to cause an increase in the ESR of the resulting capacitor 10. Accordingly, an alkaline compound is preferably added to the conductive polymer solution to adjust the pH to a value within a range from 3 to 13.

The same alkaline compounds as those contained within the treatment liquid may be used, but among these alkaline compounds, nitrogen-containing aromatic cyclic compounds are preferred. If the alkaline compound is a nitrogen-containing aromatic cyclic compound, then undoping of the polyanion from the π-conjugated conductive polymer can be reliably prevented, and the conductivity of the solid electrolyte layer 13a can be improved, enabling a further reduction in the ESR.

### <Cathode Conductive Layer Formation Step>

Following formation of the solid electrolyte layer 13a, the structure is impregnated with an electrolyte if required, and the cathode 13 is then formed, either by a method in which a carbon paste or silver paste is applied to form the cathode conductive layer 13b, or by a method in which an aluminum foil or the like is disposed on the solid electrolyte layer 13a with a separator disposed therebetween to form the cathode conductive layer 13b, thus completing the capacitor 10.

In those cases where a separator is used, examples of materials that may be used as the separator include nonwoven fabrics prepared from one or more types of fiber selected from among cellulose fibers, glass fibers, polypropylene fibers, polyester fibers and polyamide fibers and the like.

In the above method for manufacturing the capacitor 10, the affinity of the surface of the dielectric layer 12 for the π-conjugated conductive polymer can be improved by treating the surface of the dielectric layer 12 with the treatment liquid containing a salt. As a result, when the conductive polymer solution is applied to the surface of the dielectric layer 12, the conductive polymer solution is able to penetrate deeply into the interior of the dielectric layer 12. Accordingly, the solid electrolyte layer 13a is able to be formed across a broad area, meaning a higher capacitance can be realized for the capacitor 10.

Further, treating the surface of the dielectric layer 12 with the treatment liquid containing a salt expands the contact surface area at the interface between the dielectric layer 12 and the solid electrolyte layer 13a, meaning the ESR of the resulting capacitor 10 can be reduced.

Furthermore, in the above method of producing the capacitor 10, because the solid electrolyte layer 13a is formed using a solution containing a π-conjugated conductive polymer, the capacitor 10 can be manufactured at a high level of productivity.

The present invention is not limited to the embodiments described above. In the above embodiment, the cathode was formed by forming the solid electrolyte layer and subsequently providing the cathode conductive layer thereon to complete the capacitor, but in the present invention, the timing with which the cathode conductive layer is provided is not limited to that described in the above embodiment. For example, the cathode conductive layer may be positioned opposing the dielectric layer, the surface of the dielectric layer subsequently treated with the treatment liquid, and the solid electrolyte layer then formed. In such a case, a separator is preferably disposed between the cathode conductive layer and the dielectric layer.

### EXAMPLES

A more detailed description of the present invention is presented below based on a series of examples.

### (1) Preparation of Conductive Polymer Solutions

### Preparation Example 1

### Preparation of Conductive Polymer Solution (I)

14.2 g of 3,4-ethylenedioxythiophene and a solution prepared by dissolving 27.5 g of a polystyrenesulfonic acid (weight average molecular weight: approximately 150,000) in 2,000 ml of ion-exchanged water were mixed at 20° C.

With the thus obtained mixed solution undergoing constant stirring at 20° C., a solution containing 29.64 g of ammonium persulfate dissolved in 200 ml of ion-exchanged water, and 8.0 g of a ferric sulfate oxidation catalyst solution were added, and the resulting mixture was then stirred and allowed to react for 3 hours.

The resulting reaction mixture was subjected to a dialysis treatment, thereby removing the unreacted monomer and oxidant, and yielding an aqueous solution containing approximately 1.5% by mass of a polystyrenesulfonic acid-poly(3,4-ethylenedioxythiophene).

10 g of polyethylene glycol 400 was added to, and dispersed within, 10 g of the aqueous solution of polystyrenesulfonic acid-poly(3,4-ethylenedioxythiophene), thus yielding a conductive polymer solution (I).

### Preparation Example 2

### Preparation of Conductive Polymer Solution (II)

0.5 g of imidazole was added to 110 g of the conductive polymer solution (I), thus yielding a conductive polymer solution (II) with a pH of 9.

### (2) Preparation of Salt Solutions

### Preparation Example 3

### Preparation of Salt Solution (I)

0.5 g of ammonium sulfate was mixed with 9.5 g of ion-exchanged water, yielding a salt solution (I) having a pH of 7 at 25° C.

### Preparation Example 4

### Preparation of Salt Solution (II)

0.5 g of ammonium 4-sulfophthalate was mixed with 9.5 g of ion-exchanged water, yielding a salt solution (II) having a pH of 7 at 25° C.

### Preparation Example 5

### Preparation of Salt Solution (III)

0.5 g of imidazolium 5-sulfoisophthalate was mixed with 9.5 g of ion-exchanged water, yielding a salt solution (III) having a pH of 8 at 25° C.

### Preparation Example 6

### Preparation of Salt Solution (IV)

0.5 g of lithium 5-sulfoisophthalate was mixed with 9.5 g of ion-exchanged water, yielding a salt solution (IV) having a pH of 7 at 25° C.

### Preparation Example 7

### Preparation of Salt Solution (V)

0.5 g of ammonium benzoate was mixed with 9.5 g of ion-exchanged water, yielding a salt solution (V) having a pH of 7 at 25° C.

### Preparation Example 8

### Preparation of Salt Solution (VI)

0.5 g of sodium dodecylbenzenesulfonate was mixed with 9.5 g of ion-exchanged water, yielding a salt solution (VI) having a pH of 8 at 25° C.

### Preparation Example 9

### Preparation of Salt Solution (VII)

0.5 g of polyethylene glycol 400 and 0.5 g of ammonium 4-sulfophthalate were mixed with 9.5 g of ion-exchanged water, yielding a salt solution (VII) having a pH of 7 at 25° C.

### Preparation Example 10

### Preparation of Salt Solution (VIII)

0.5 g of polyethylene glycol acrylate and 0.5 g of ammonium adipate were mixed with 9.5 g of ion-exchanged water, yielding a salt solution (VIII) having a pH of 7 at 25° C.

### Preparation Example 11

### Preparation of Salt Solution (IX)

0.5 g of a polyurethane aqueous solution (solid fraction concentration: 40% by mass, manufactured by Kusumoto Chemicals, Ltd.), 0.23 g of para-toluenesulfonic acid and 0.1 g of N-vinylimidazole were mixed with 9.5 g of ion-exchanged water, yielding a salt solution (IX) having a pH of 8 at 25° C.

### Preparation Example 12

### Preparation of Salt Solution (X)

0.5 g of ethylmethylimidazolium trifluoromethanesulfonate was mixed with 9.5 g of ion-exchanged water, yielding a salt solution (X) having a pH of 7 at 25° C.

### (3) Production of Capacitors

### Production Example 1

An anode lead terminal was connected to an etched aluminum foil (an anode foil), and was then subjected to a chemical conversion treatment (an oxidation treatment) by applying a voltage of 100 V within a 10% by mass aqueous solution of ammonium adipate, thereby forming a dielectric layer on both surfaces of the aluminum foil and yielding an anode foil.

Next, opposing aluminum cathode foils with a cathode lead terminal welded thereto were laminated to both surfaces of the anode foil with a cellulose separator disposed therebetween, and the resulting laminate was then wound into a circular cylindrical shape to form a capacitor element.

### Example 1

The capacitor element obtained in production example 1 was dipped, under reduced pressure conditions, in the salt solution (I) prepared in preparation example 3, and was subsequently dried for 10 minutes at 120° C. using a hot air dryer. Subsequently, the capacitor element was dipped, under reduced pressure conditions, in the conductive polymer solution (I) prepared in preparation example 1, and was then dried for 30 minutes at 120° C. using a hot air dryer. This dipping in the conductive polymer solution (I) was repeated 3 times, thereby forming a solid electrolyte layer containing a π-conjugated conductive polymer on the surface of the dielectric layer.

Subsequently, the capacitor element with the solid electrolyte layer formed thereon was packed in an aluminum case and sealed with a sealing rubber to complete preparation of a capacitor.

The electrostatic capacitance at 120 Hz and the initial value of the equivalent series resistance (ESR) at 100 kHz for the prepared capacitor were measured using a LCZ meter 2345 (manufactured by NF Corporation). The results are shown in Table 1. The ESR is an indicator of the impedance.

### Example 2

With the exception of using the conductive polymer solution (II) instead of the conductive polymer solution (I), a capacitor was prepared in the same manner as example 1. The electrostatic capacitance and the ESR were then measured in the same manner as example 1. The results are shown in Table 1.

### Example 3

With the exception of using the salt solution (II) instead of the salt solution (I), a capacitor was prepared in the same manner as example 1. The electrostatic capacitance and the ESR were then measured in the same manner as example 1. The results are shown in Table 1.

### Example 4

With the exception of using the salt solution (III) instead of the salt solution (I), a capacitor was prepared in the same manner as example 1. The electrostatic capacitance and the ESR were then measured in the same manner as example 1. The results are shown in Table 1.

### Example 5

With the exception of using the salt solution (IV) instead of the salt solution (I), a capacitor was prepared in the same manner as example 1. The electrostatic capacitance and the ESR were then measured in the same manner as example 1. The results are shown in Table 1.

### Example 6

With the exception of using the salt solution (V) instead of the salt solution (I), a capacitor was prepared in the same manner as example 1. The electrostatic capacitance and the ESR were then measured in the same manner as example 1. The results are shown in Table 1.

### Example 7

With the exception of using the salt solution (VI) instead of the salt solution (I), a capacitor was prepared in the same manner as example 1. The electrostatic capacitance and the ESR were then measured in the same manner as example 1. The results are shown in Table 1.

### Example 8

With the exception of using the salt solution (VII) instead of the salt solution (I), a capacitor was prepared in the same manner as example 1. The electrostatic capacitance and the ESR were then measured in the same manner as example 1. The results are shown in Table 1.

### Example 9

With the exception of using the salt solution (VIII) instead of the salt solution (I), a capacitor was prepared in the same manner as example 1. The electrostatic capacitance and the ESR were then measured in the same manner as example 1. The results are shown in Table 1.

### Example 10

With the exception of using the salt solution (IX) instead of the salt solution (I), a capacitor was prepared in the same manner as example 1. The electrostatic capacitance and the ESR were then measured in the same manner as example 1. The results are shown in Table 1.

### Example 11

With the exception of using the salt solution (X) instead of the salt solution (I), a capacitor was prepared in the same manner as example 1. The electrostatic capacitance and the ESR were then measured in the same manner as example 1. The results are shown in Table 1.

### Example 12

With the exception of using the salt solution (II) instead of the salt solution (I), a capacitor was prepared in the same manner as example 2. The electrostatic capacitance and the ESR were then measured in the same manner as example 1. The results are shown in Table 1.

### Example 13

With the exception of using the salt solution (III) instead of the salt solution (I), a capacitor was prepared in the same manner as example 2. The electrostatic capacitance and the ESR were then measured in the same manner as example 1. The results are shown in Table 1.

### Example 14

With the exception of using the salt solution (IV) instead of the salt solution (I), a capacitor was prepared in the same manner as example 2. The electrostatic capacitance and the ESR were then measured in the same manner as example 1. The results are shown in Table 1.

### Example 15

With the exception of using the salt solution (V) instead of the salt solution (I), a capacitor was prepared in the same manner as example 2. The electrostatic capacitance and the ESR were then measured in the same manner as example 1. The results are shown in Table 1.

### Example 16

With the exception of using the salt solution (VI) instead of the salt solution (I), a capacitor was prepared in the same manner as example 2. The electrostatic capacitance and the ESR were then measured in the same manner as example 1. The results are shown in Table 1.

### Example 17

With the exception of using the salt solution (VII) instead of the salt solution (I), a capacitor was prepared in the same manner as example 2. The electrostatic capacitance and the ESR were then measured in the same manner as example 1. The results are shown in Table 1.

### Example 18

With the exception of using the salt solution (VIII) instead of the salt solution (I), a capacitor was prepared in the same manner as example 2. The electrostatic capacitance and the ESR were then measured in the same manner as example 1. The results are shown in Table 1.

### Example 19

With the exception of using the salt solution (IX) instead of the salt solution (I), a capacitor was prepared in the same manner as example 2. The electrostatic capacitance and the ESR were then measured in the same manner as example 1. The results are shown in Table 1.

### Example 20

With the exception of using the salt solution (X) instead of the salt solution (I), a capacitor was prepared in the same manner as example 2. The electrostatic capacitance and the ESR were then measured in the same manner as example 1. The results are shown in Table 1.

### Comparative Example 1

With the exception of not dipping the capacitor element in the salt solution (I), a capacitor was prepared in the same manner as example 1. The electrostatic capacitance and the ESR were then measured in the same manner as example 1. The results are shown in Table 1.

### Comparative Example 2

With the exception of not dipping the capacitor element in the salt solution (I), a capacitor was prepared in the same manner as example 2. The electrostatic capacitance and the ESR were then measured in the same manner as example 1. The results are shown in Table 1.

TABLE 1

| | | Electrostatic | |
|---|---|---|---|
| | | capacitance (μF) | ESR (mΩ) |
| Example | 1 | 47 | 33 |
| | 3 | 57 | 28 |
| | 4 | 54 | 29 |
| | 5 | 49 | 67 |
| | 6 | 51 | 32 |
| | 7 | 43 | 65 |
| | 8 | 57 | 25 |
| | 9 | 56 | 27 |
| | 10 | 52 | 28 |
| | 11 | 53 | 31 |
| | 12 | 56 | 17 |
| Comparative | 1 | 35 | 80 |
| example | | | |
| Example | 2 | 53 | 18 |
| | 13 | 57 | 17 |
| | 14 | 55 | 17 |
| | 15 | 53 | 19 |
| | 16 | 54 | 19 |
| | 17 | 57 | 17 |
| | 18 | 56 | 17 |
| | 19 | 54 | 18 |
| | 20 | 55 | 19 |
| Comparative | 2 | 42 | 30 |
| example | | | |

The capacitors of examples 1 to 20, which were obtained by treating the surface of the dielectric layer with a treatment liquid containing a salt, were able to realize an increase in the capacitance. Further, the capacitors of example 2 and examples 12 to 20, which were obtained using a conductive polymer solution containing imidazole yielded lower values for the ESR than the capacitors prepared using conductive polymer solutions that did not contain imidazole.

In contrast, the capacitors of comparative examples 1 and 2, which were obtained without treating the dielectric layer with a treatment liquid, exhibited significantly lower capacitance values.

The capacitor of the present invention is able to realize a high capacitance, and also has a low ESR. The method of producing a capacitor according to the present invention is capable of manufacturing a capacitor having a high capacitance and a low ESR at a high level of productivity.

What is claimed is:

1. A capacitor comprising
an anode composed of a valve metal and having unevenness formed in a surface thereof,
a dielectric layer formed by oxidizing a surface of said anode, and
a cathode formed on a surface of said dielectric layer and having a solid electrolyte layer comprising a π-conjugated conductive polymer and a polyanion, wherein
a portion of, or all of, a cathode-side surface of said dielectric layer is treated with a salt.

2. The capacitor according to claim 1, wherein said salt is a salt of a nitrogen-containing cation and an anion.

3. The capacitor according to claim 1, wherein a conductivity improver is added to said salt used for treating said cathode-side surface of said dielectric layer.

4. The capacitor according to claim 1, wherein an ion-conducting compound is added to said salt used for treating said cathode-side surface of said dielectric layer.

5. A method of producing a capacitor, comprising the step of:
forming a dielectric layer by oxidizing a surface of an anode composed of a valve metal,
treating a surface of said dielectric layer with a treatment liquid comprising a salt and a solvent, and
forming a solid electrolyte layer by applying a conductive polymer solution comprising a π-conjugated conductive polymer, a polyanion and a solvent to a surface of said dielectric layer that has been treated with said salt.

6. The method of producing a capacitor according to claim 5, wherein said salt is a salt of a nitrogen-containing cation and an anion.

7. The method of producing a capacitor according to claim 5, wherein said treatment liquid further comprises a conductivity improver.

8. The method of producing a capacitor according to claim 5, wherein said treatment liquid further comprises an ion-conducting compound.

9. The method of producing a capacitor according to claim 5, wherein a pH of said treatment liquid at 25° C. is within a range from 3 to 12.
